(19) United States
(12) Patent Application Publication
(10) Pub. No.: US 2005/0053050 A1
(43) Pub. Date: Mar. 10, 2005

(54) Custom routing of object requests

(76) Inventors: Keith Ballinger, North Bend, WA (US); HongMei Ge, Issaquah, WA (US); Hervey Oliver Wilson, Bellevue, WA (US); Vick Bhaskar Mukherjee, Redmond, WA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/645,279

(22) Filed: Aug. 20, 2003

(51) Int. Cl. G06F 15/173

(52) U.S. Cl. 370/351

(57) ABSTRACT

A sending computer system relays a message or a processing request through one or more configurable routers prior to the message or request reaching an ultimate destination. A client at the sending computer system can indicate a routing preference for the message or request, and a module can supplement or override the routing preference by adding or deleting a router from a router list contained within the message or request. This change can be done based on router data, as well as based on content within the message. One or more intermediate routers along the routing path can perform a similar function as the module. The ultimate destination, or receiving computer system, verifies that it is the appropriate recipient of the message or request, and then accepts the data associated with the message or request. This has application to many types of messaging systems, including simple object access protocols.

### BACKGROUND OF THE INVENTION

1. The Field of the Invention

This invention relates to systems, methods, and computer program products for routing messages such as Simple Object Access Protocol (SOAP) messages between computer systems over one or more routers.

2. Background and Relevant Art

Computerized systems provide many advantages toward people's ability to perform tasks. To enable these advantages, computer systems often come equipped with (or are expandable to include) multiple hardware devices that can store or read data, or enable a software program to perform a specific action on data. Such devices can include, for example, a hard drive, a Compact Disc (i.e., CDROM, CDRW, etc.), a Universal Serial Bus (USB) device (e.g., a printer, a scanner, etc.), and so on. Present computer systems also commonly have installed thereon multiple software (or “application”) programs such as a word processing program, a spreadsheet program, an imaging program, and an electronic mail program, which instruct the devices to perform specific actions on the data.

Accordingly, a user will often implement multiple devices and multiple application programs on a computer system so that the user can have many tools available for performing various tasks. There are, however, many limits to this sort of approach. For example, cost issues become apparent since applications and additional devices can each be very expensive, depending on the types of tasks the user wishes to perform.

Furthermore, computer systems typically have a finite number of “expansion ports” to add new devices, and have a finite amount of storage space on which a user can install additional application programs. Of course, these limitations are exacerbated by the fact that multiple devices and application programs often create significant resource (e.g., CPU cycles, random access memory, etc.) drains on a computer system. Accordingly, it is well known that not all of a user's task requirements can be solved adequately simply by adding an additional device or an application program.

Presently, some solutions have been designed to help accommodate these sorts of limitations. For example, computer systems on a Local or Wide Area Network (LAN, or WAN) often have access to network resources that can include use of a network storage device, or processing resources on another network computer. These solutions, however, generally require that the computer the user wishes to use on the respective network communicate using a specific communication protocol (whether an application-specific, an operating system-specific, or a network communication protocol, etc.). In addition, these methods do not provide relief to computer systems that have many devices or applications installed on the machine.

Other solutions, however, are geared more toward handling specific tasks needed by an application program on a computer system. Such solutions, such as, for example, the Simple Object Access Protocol (SOAP) allow users to reduce the resource requirements otherwise needed to handle the respective application requests. Generally, solutions for handling specific processing requests involve an installed application on one computer system requesting another computer system over a network to process an object (e.g., a set of instructions), rather than requiring the computer system on which the application is installed to process the instructions. The messages invoking such requests are ideal in that they are not typically limited to a specific operating system, application, or network communication protocol. In particular, since computer system applications normally send messages such as these in a markup language (e.g., eXtensible Markup Language—XML), such messages can be understood by many operating systems and communication protocols.

One problem with, for example, object processing requests, is that messages like these are normally limited to the peer-to-peer environment (i.e., communicated between computer systems directly). This can create certain network and security disadvantages, and can keep an application from maximizing the available benefits of using a SOAP (or other system and protocol-independent messages). For example, it may be desirable to keep a computer dedicated to processing tasks in a “Marketing” group from sending object requests to a computer in an “Engineering” group, and vice versa. Similarly, it may be desirable to restrict message processing requests to certain geographic boundaries, rather than allowing processing requests to be sent across a WAN to a computer system in another country. Presently, there are limited, if any, mechanisms for restricting outgoing processing requests in this manner.

Accordingly, systems, methods, and computer program products that relay object requests over one or more routers, rather than only in a peer-to-peer framework would be advantageous. In addition, administering outgoing object requests that can be routed in an efficient, preferred manner prior to the object request reaching its intended destination would be advantageous.

### BRIEF SUMMARY OF THE INVENTION

The foregoing problems with the prior state of the art are overcome by the principles of the present invention, which are directed towards methods, systems, and computer program products for routing a message from a sending computer system to a receiving computer system such that a routing path for the message can be changed before the message reaches the receiving computer system. In particular, since the present invention provides for sending the message over at least one router, rather than simply through a peer-to-peer transmission, the present invention allows for more enhanced, configurable control over how a computer system sends a message to another computer system.

In accordance with a preferred embodiment of the present invention, a sending computer system prepares a message, such as a SOAP message, for sending to a receiving computer system by including in the message an indication of an ultimate destination (i.e., the receiving computer system) for the message, and a router list. An application at the sending computer system compares the router list included in the message with a cached router list before the message is sent onto the network. The application can also review the content of the message. Based on a comparison of routing rules with one or more of an ultimate destination identifier, the included router list, the cached router list, and the content of the message, the application then adds or deletes a router from the router list included in the message as appropriate.

An initial router then receives the message and determines that it is an appropriate recipient of the message, in part by determining that it is the “top-most” router on the included router list. If the initial router is the appropriate recipient, the initial router also compares routing rules with one or more of the ultimate destination identifier included in the message, a cached router list stored at the router, the router list included in the message, and the content of the message. The initial router then adds or deletes any other router from the router list as appropriate, and relays (or “routes”) the message to a next router on the included router list. Similar comparison logic can be made at any subsequent (or “next”) router that receives the message. Since the present invention provides for dynamic routing assignments as well as content-based routing along in this manner, the present invention allows a high degree of routing configurability.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention cam be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary routing environment useful for practicing a preferred embodiment of the present invention;

FIG. 2 illustrates a more particular view of a routing environment useful for practicing a preferred embodiment of the present invention;

FIG. 3 illustrates an example flow chart of a method for routing a message from a sending computer system to a receiving computer system such that a routing path for the message can be changed before the message reaches the receiving computer system; and

FIG. 4 illustrates an example flow chart for routing a message with particular attention to the client, message-creation perspective;

FIG. 5 illustrates an exemplary computing system environment for practicing the present invention.

### DETAILED DESCRIPTION OF THE PREFERRED EMBODIMENTS

The present invention extends to both methods, systems, and computer program products for routing a message from a sending computer system to a receiving computer system such that a routing path for the message can be changed before the message reaches the receiving computer system. The embodiments of the present invention may comprise a special purpose or general-purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

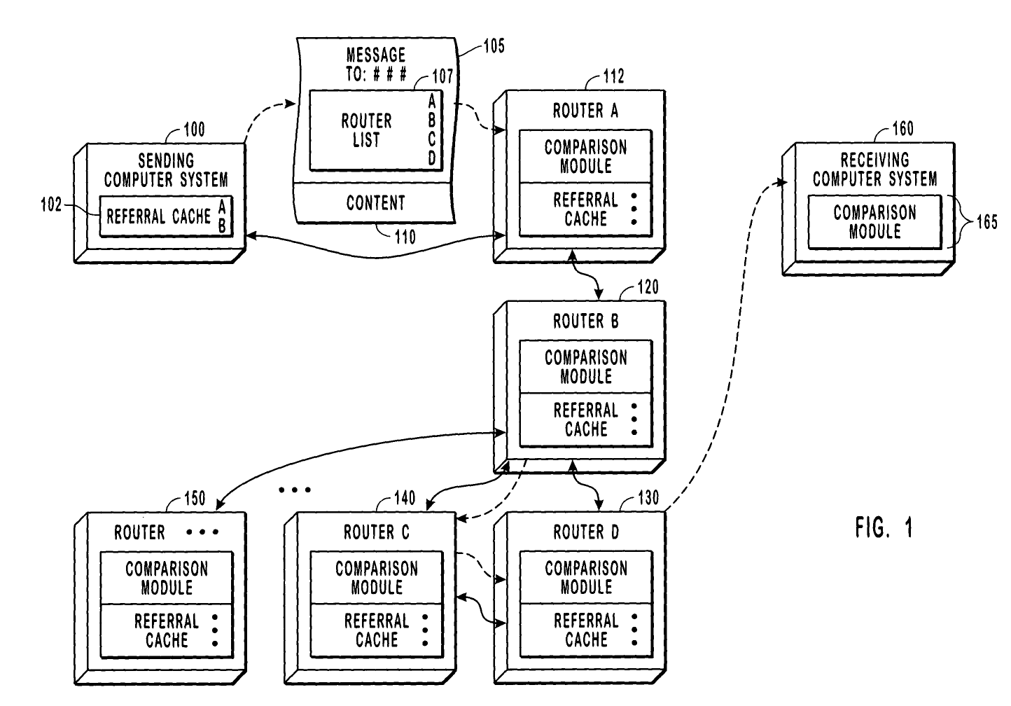

Turning now to FIG. 1, the figure illustrates an exemplary routing environment useful for practicing a preferred embodiment of the present invention. As shown, a client such as a user or an application program that intends to send a message 105 initiates the message 105 at a sending computer system 100. For the purposes of the specification and claims, the term “message” can refer to object processing requests, such as in a Simple Object Access Protocol (SOAP) message. In addition, an “object” refers generally to a set of instructions or routines that a sending computer system intends another computer system to process. Nevertheless, although the invention will be described with particular attention given to SOAP messages, one will appreciate after reading the specification and claims that the invention can be practiced in any environment where messages are sent from a sending computer system to a receiving computer system.

Continuing with FIG. 1, message 105 is shown including a “To:” portion, a router list portion 107, and a content portion 110. The router list 107 is shown including routers “A”, “B”, “C”, and “D”. In at least one embodiment of the present invention, this router list can represent sequential router preferences (e.g., a user's or application's preferences) for how message 105 should be routed to a receiving computer system 160. For example, a user or application might prefer to route messages through secure routers only during certain hours of the day. Hence, a user could enter in a router choice field of an interface, or in an application set up that the user would prefer to use routers “A”, “B”, “C”, and “D” during an indicated time frame. Alternatively, the user or application could also indicate no router preference.

The content portion 110 can represent the nature of the object requests, as well as any text input by a user that could be included in any ordinary message. For example, the content portion 110 could include electronic mail text sent between users, can include raw data of a report generated in a program, and can include a set of instructions to be processed at another computer on raw data contained in the message. As will be described in the specification and claims, the content 110 may also serve as a basis for routing decisions by the sending computer system 110 and any intermediate router.

In response to an indication that message 105 will be sent (e.g., a user selects to send message 105), the sending computer system 100 can reference a set of instructions in a referral cache 102. The set of instructions can be, for example, any number of routing instructions that can be understood in a network routing environment such as, for example, the MICROSOFT® Web Services Enhancements (WSE) used in the MICROSOFTO NET® environment. The referral cache 102 can be a centralized database of router identities (e.g., router 112, 120, etc.) that is administered by a network administrator and stored locnally at the computer system 100, or can be a list of routers compiled by the computer system 100 over the course of several successful send and receive sequences with other computer systems (e.g., receiving computer system 160).

In response to instructions in referral cache 102, the sending computer system 100 adds or deletes a router from the router list 107, if appropriate. Then, when the sending computer system 100 sends the message 105 to an ultimate destination, the message is first relayed to the “top-most” router on the router list. The term “top-most” router for the purposes of the specification and claims refers to a specific point of sequence in the router list, whereby the “top-most” router is the router to which a message will be sent, or is the router where the message is appropriately received before the router performs any operations on the message.

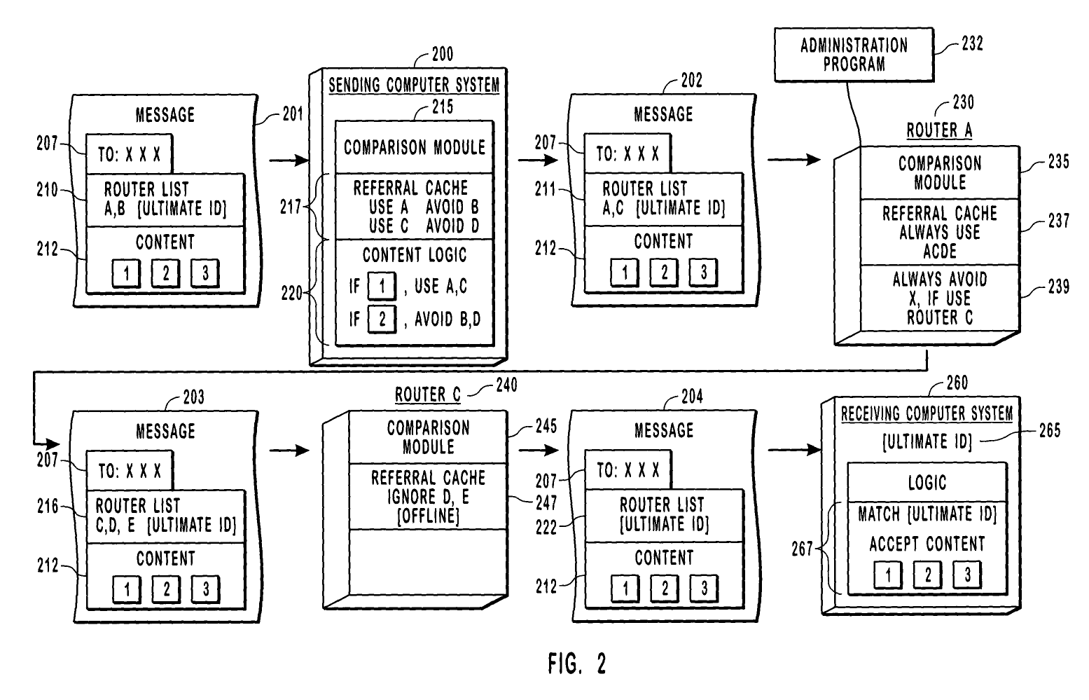

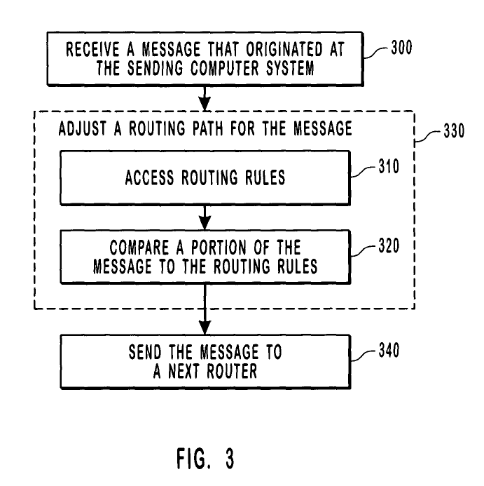

As shown in FIG. 1, “Router A” 112 is the top most router in router list 107, and hence the first router to receive the message. “Router A” 112 includes a referral cache and a comparison module. Succinctly, when “Router A” 112 receives the message 105, the router executes instructions at the comparison module (as will be illustrated more fully in FIGS. 2 and 3), and sends the message 105 along to a “next” appropriate router (e.g., “Router B” 120).

For the purposes of the specification and claims, the term “router” can flexibly refer to any of the one or more intermediate routers, as well as the ultimate destination (e.g. receiving computer system 160) in the routing path since each can be referred to in the “routing list” 107. For example, a router can represent a single computer system that includes one or more of the components of a typical computer system. In addition, a router can represent a virtual directory on a single computer system that includes one or more virtual directories. Hence, although the “Sending Computer System” 100 and the “Receiving Computer System” 160 might not ordinarily be referenced to as a “router”, they will be referred to as a “router” for the purposes of this specification and claims. In at least one preferred embodiment of the present invention, the respective computer systems 100 and 160 perform similar functions as the intermediate routers (112, 120, etc.), and can be identified in the router list 107.

In accordance with the present invention, once a router (e.g., router 112) receives the message 105, executes determinative logic based on the message 105, and then relays the message 105 to a “next router”, each subsequent intermediate router (e.g., routers 120, 130, etc.) can perform the same or similar functions before the message 105 reaches the “ultimate destination” (e.g., “Receiving Computer System” 160). Routing messages (e.g., message 105) in this manner could occur at routers on any LAN or WAN, including the Internet.

Thus, for example, FIG. 1 illustrates that numerous routing paths are possible for message 105, such that message 105 could be routed through router 112, and the following routers 120, 130, 140, and 150 (or more), in any sequence. In particular, each router 120, 130, 140, and 150 is shown with a respective comparison module and referral cache as similarly described for router 112, which can allow an administrator to configure each router to route messages based on certain criteria. As well, an administrator could configure the initial router (e.g., “Router A” 112”) simply to be the only intermediate router in path for message 105, and thus route the message 105 directly to the “Receiving Computer System” 160 without requiring the message 105 to be relayed at any of the other possible intermediate routers. In any case, when the “ultimate destination” (e.g., “Receiving Computer System” 160) receives the message 105, whether from “Router A” 112 or some other intermediate router, the ultimate destination executes a similar determinative logic as router 112 to ensure it is the appropriate recipient of the message 105.

FIG. 2 illustrates a more particular view of a routing environment useful for practicing a preferred embodiment of the present invention. FIG. 2 also shows how each router or computer system can interact with a referral cache and/or message content to change the routing path of a message. Accordingly, the figure illustrates a “Sending Computer System” 200, a “Router A” 230, a “Router C” 240, and a “Receiving Computer System” 260. The figure also shows an exemplary message 201 in accordance with one preferred embodiment of the present invention in various subsequent states (e.g., message 202, message 203, and message 204).

Initially, a client creates a message 201 at a computer system (e.g., “Sending Computer System” 200). In a preferred embodiment, the message 201 is created using a markup language, such as XML. Markup languages such as XML are particularly useful for practice with the present invention since they can treat a message as several discrete, readily-identifiable portions. These message portions can be as general as metadata in a document header, or text in a content portions, and as functional as a set of instructions in a defined, document object. These message portions can include data, such as, for example, metadata in a message header (e.g., in a SOAP header) or the contents of a message payload (e.g., in a SOAP body).

More specifically, the message 201 can include a “To:” portion 207, a router list portion 210, and a content portion 212. The “To:” field 207 can refer to a specific “ultimate destination identifier” for a recipient computer system (e.g., “Receiving Computer System” 230), or could be a virtual name (e.g. an email alias, a domain name) for any number of Internet Protocol (IP) addresses, Uniform Resource Locators (URL), Global Unique Identifiers (GUID), and so forth. In similar fashion, the router list portion 210 can include a list of preferred router names or addresses, if the user is inclined to enter router preferences through an interface (not shown), and can include the “ultimate destination identifier” (e.g, “A”, “B”, and “Ultimate ID”). The content portion 212 (e.g., “1”, “2”, and “3”) can be any type of identifiable data such as a text message between two users, or as complex as a remote request to perform discrete mathematical operations on one or more data sets.

Before the sending computer system 200 relays the message 201 to the “top-most” router (i.e., “A” in router list 210), a comparison module 215 at the sending computer system 200 may perform one or more operations on the message 201. In one embodiment, the comparison module 215 can reference a “Referral Cache” 217 at the computer system 200, which identifies a list of required router instructions (i.e., as distinguished from the preferred routers entered into router list 210) based on certain router criteria. In another embodiment, the comparison module 215 could reference “Content Logic” 220, which can provide content-based routing instructions in an alternative to referencing the “Referral Cache” 217, or in addition to referencing the “Referral Cache” 217. These routing criteria that identify required routers, and routing instructions based on message content are sometimes referred to herein generally as “routing rules” (not shown explicitly as a file or diagrammatic block).

Accordingly, the “Referral Cache” 217 can provide the comparison module 215 with routing rules that describe routing based on one or more of router identities, router geographic locations, router network locations, or router security settings, etc. The routing rules provided through the referral cache can be stored and manually administered from a local or a remote location (e.g., via “Administration Program” 232). The routing rules can also be automatically updated in the “Referral Cache” 217 in each computer system—and the referral cache in any intermediate router (e.g., referral caches 237, 247)—based on successful incoming and outgoing messages. Thus, “Referral Cache” 217 indicates one or more routers to which the message 201 should be routed (“A”, “C”), and/or could also indicate one or more routers that the message 201 should avoid (“B”, “D”). One will appreciate after reading the disclosure and claims, however, that the referral cache might not use any “avoid” rules as such, and might base its instructions explicitly on using one router if another is also used.

The content logic 220 can also provide the comparison module 215 with routing rules (not shown) that describe routing based on message content 212. For example, in one embodiment, the comparison module 215 can reference content logic 220 as it parses the content 212 of message 201. The content logic 220 then instructs the comparison module that if content 212 data “1” is present in message 201, the message 201 should be relayed to routers “A” and “C”; and if content 212 data “2” is present is present in message 201, the message 201 should be relayed so as to avoid routers “B” and “D”. Furthermore, it will be appreciated after reading the specification and claims that the content logic 220 could also be configured to define negative rules such that, if data “4” is missing, do not route to router “J”. In any event, the routing rules provided through the content logic 220 can be referenced by the comparison module 215 in addition to (or in alternative to) what has been provided by the “Referral Cache” 217.

Based on routing rules included in the comparison module 215, provided by the “Referral Cache” 217, and/or provided by the content logic 220, the comparison module 215 can add or delete a router from the router list 210 of message 201. This is illustrated as the comparison module alters router list 210 to router list 211 (message 202), in order to reflect the appropriate routing sequence. Thus, FIG. 2 illustrates message 201 passing through comparison module 215 to become message 202, which is altered to include the same “To:” portion 207, the same content data 212 (i.e., “1”, “2”, and “3”), and a modified router list 211. Message 202 reflects that the routing list 211 requires that the message 202 be relayed through routers “A” and “C” (rather than “A” and “B” in message 201) before being passed to the receiving computer system 260, identified by “Ultimate ID”. Thus, when the message 202 is finally sent from the sending computer system 200, the message 202 is first relayed to the “top-most” router (or, next router in the sequence) on the modified router list 211, (i.e., “Router A” 230). “Router A” 230 includes a similar comparison module (e.g. “Comparison Module” 235) as in the sending computer system 200; however, “Router A” 230 can also include its own “Referral Cache” 237, and separate set of additional instructions, such as instructions 239, etc.

Accordingly, when “Router A” 230 receives message 202, “Router A” 230 will check initially to see that it is the correct, intended recipient of message 202. “Router A” 230 does so by identifying the router that is the “top-most” router on the router list 211, and by confirming that the “top-most” router on the router list 211 identifies “Router A” 230. As illustrated, since “A” appears as “top-most” router (or the next router in sequence) on the router list 211, “Router A” will properly identify itself as the appropriate recipient of message 202. If “Router A” identifies, however, that it is not the appropriate recipient of the message 202, “Router A” can return the message 202 to the sending computer system 200, and can alternatively forward the message 202 to the “top-most” router identified in the router list 211.

Having identified that “Router A” 230 is the correct recipient, “Router A” 230 also performs one or more operations on the message 202 through comparison module 235, prior to forwarding the message 202 along the intended routing path. For example, “Router A” 230 has instructions (provided through “Referral Cache” 237) that each of routers “A”, “C”, “D”, and “E” should be used. “Router A” 230 also has instructions 239 that indicate that router “X” should be avoided whenever router “C” is used in the routing path. These instructions might apply when, for example, router “C” is a publicly-available router, and router “X” is intended only for secure or private use. It will be appreciated after reviewing the specification and claims, therefore, that these instructions could be generally applicable, or could be applicable only to messages originating from sending computer system 200, or when sending certain types of messages (i.e., secure/non-secure), etc.

Based on routing rules included in “Router A's” 230 comparison module 235, and provided by the instructions 237, 239, the comparison module 235 can then add or delete a router from the router list 211 of message 202. Thus, message 202 passes through “Router A's” comparison module 235 to become message 203, so that the router list is modified to become router list 216. In addition, before “Router A” relays message 203, “Router A” removes its router identifier (e.g., “A” from 211) from the router list, so that the message 203 is then relayed to the next, “top-most” router on the modified router list 216, (i.e., “Router C” 240). Message 203, reflects this modification, indicating that the message 203 will be relayed through routers “C”, “D”, and “E” before being passed to the receiving computer system 260, identified by “Ultimate ID”. Accordingly, “Router A” 230 then relays message 203 to “Router C” 240.

When “Router C” 240 receives message 203, “Router C” 240 first identifies that it is the intended recipient of the message 203, by identifying that “C” appears as the “top-most” (or next in sequence) router on the router list 216. After identifying that “Router C” 240 is the correct recipient of message 203, “Router C” 240 also performs one or more operations on the message 203 through its own comparison module. For example, “Router C” 240 includes “Comparison Module” 245 that can also include its own instructions in the form of a “Referral Cache” 247. Notably, “Router C's” 230 comparison module 245 will perform the one or more operations independent of whatever has been done by any other intermediate routers (e.g., “Router A”). This independence is one way in which the present invention provides significant routing flexibility.

As shown in the “Referral Cache” 247 for “Router C” 240, routers “D” and “E” are indicated as being offline, and so should be ignored or removed from any router list, to therefore avoid any routing errors. Thus, “Router C” 240 implements its instructions from the referral cache 247 (i.e., to ignore routers “D” and “E”), and therefore removes routers “D” and “E” from router list 216. And, as with “Router A”, “Router C” 240 also removes its own router identifier (i.e., “C”) from the router list 216 so that the remaining router identifier “Ultimate ID” is the next, or “top-most” router in the router list. “Router C” implements these changes by modifying message 203 to become message 204, as further reflected in the modified routing list 222. “Router C” 240 then relays message 204 to the destination identified in the routing list 222 by “Ultimate ID” (i.e., “Receiving Computer System” 260).

When “Receiving Computer System” 260 receives message 204 from “Router C” 240, the “Receiving Computer System” 260 first identifies whether it is the appropriate recipient of the message 204. To do so, the “Receiving Computer System” ok 260 implements one or more modules that are similar to those described for the “Sending Computer System” 200 and the intermediate routers. Accordingly, the “Receiving Computer System” 260 identifies the “top-most” router on the router list 222, and identifies that “Ultimate ID” on router list 222 matches “Ultimate ID” 265 at the “Receiving Computer System” 260. Once the “Receiving Computer System” 260 identifies that it is the appropriate recipient of the message 240, the “Receiving Computer System” accepts the content, as shown in item 267.

The present invention may also be described in terms of methods, comprising functional steps and/or non-functional acts. FIG. 3 illustrates an example flow chart of a method in accordance with the present invention for routing a message from a sending computer system to a receiving computer system such that a routing path for the message can be changed before the message reaches the receiving computer system. The method of FIG. 3 will be discussed with respect to the executable modules and files in FIG. 2.

As illustrated, the method in FIG. 3 includes an act 300 of receiving a message that originated at the sending computer system. Act 300 includes receiving a message that originated at the sending computer system and that is to be delivered to the receiving computer system, the message having at least a router list that identifies one or more routers, an ultimate destination identifier, and message content. For example, “Sending Computer System” 200 can initiate a message 202 to be relayed to a router (e.g., “Router A” 230), wherein the message 202 includes a router list 211 that identifies an “Ultimate ID”, and includes message content 212. “Router A” 230 then accesses the message.

In addition to performing act 300, the method includes a functional, result-oriented step for adjusting a routing path for the message (step 330). Step 330 can include any corresponding acts for adjusting a routing path for the message based in part on the ultimate destination indicated in the message, the routing list included in the message, and a referral cache. In the illustrated method of FIG. 3, however, step 330 includes an act 310 of accessing routing rules; and further includes an act 320 of comparing a portion of the message to the routing rules.

Act 310 includes accessing routing rules that specify how the message should be routed to the receiving computer system. For example, the router 230 can include a referral cache 237 that indicates which routers to use. If the incoming message 202 has a router list 211 that misses (or has more than) any of these routers from referral cache 237, the router 230 can add or delete routers from the router list 211 as appropriate. Furthermore, the router 230 can include other rules 239 that can dictate more specific situations for a routing path, such that if the message avoids router “X”, if the message has been relayed through router “C”.

Act 320 includes comparing at least a portion of the message to the routing rules to determine whether the router list should be reconfigured, wherein the router adds or deletes one or more routers in the router list as appropriate. Thus, as stated, if the router list 211 from the incoming message 202 is missing (or has more than) any router from the router's 230 referral cache 237, the router 230 can adjust the router list (router list 211 becomes router list 216) as appropriate. As well, the router 230 can use a comparison module 235 to look at content-based rules, similar to the sending computer system's 200 “content logic” 220, whereby the router 230 can change, e.g., routing list 211 so that a message is routed to router “C” when content “1” (e.g., content 212) is present in the message. In addition, the router 230 will remove its identification from the router list 211 so that, in router list 216, the next router (e.g., “C”, of message 203) in the router path is the “top-most” router. Notably, there is no fixed order between acts 310 and 320.

The method of FIG. 3 further comprises an act 340 of sending the message to a next router. Act 340 includes sending the message to a next router in the router list, wherein the next router identifies that it is an appropriate recipient for the message. For example, upon performing the above-described operations, “Router A” 230 can relay message 203 to another intermediate router (e.g., “Router C” 240 under a similar scenario as previously described), or directly to “Receiving Computer System” 260. This will occur when “Router A” receives or modifies message 202 to appear as message 204, such that “Ultimate ID” is the “top-most” router in the router list 222.

Upon receiving the message 204 “Receiving Computer System” 260 then matches its identification 265 with the “top-most” router on router list 222 to confirm that “Receiving Computer System” 260 is the appropriate recipient of the message 203. If “Receiving Computer System” 260 is not the appropriate recipient (i.e., no match), “Receiving Computer System” 260 can send an error message, or return the message 203 to the previous router. If “Receiving Computer System” 260 is the appropriate recipient, “Receiving Computer System” 260 can perform operations on the message for further relay, or accept (267) the data as appropriate. Accordingly, the inventive method provides flexible routing of messages between sending and receiving computer systems such that a message's routing path can change in transit.

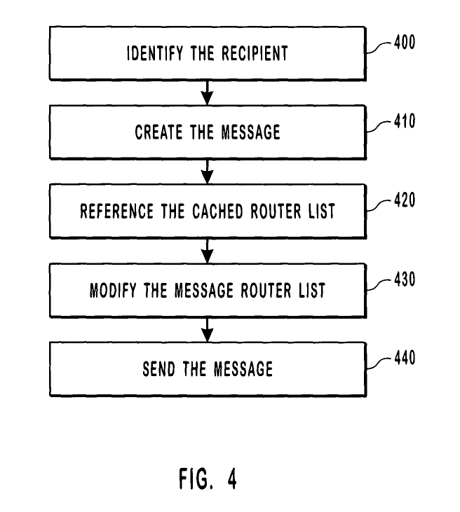

FIG. 4 illustrates a second flowchart of the present invention from the client (or message creation) perspective. The illustrated method comprises an act 400 of identifying the recipient. Act 400 includes identifying the receiving computer system, and one or more preferred routers by which the message is intended to be relayed to the receiving computer system. For example, a user at (or an application program installed on) the “Sending Computer System” 100 can (e.g., “TO:” 207, or “Ultimate ID” in router list 210). The method further comprises an act 410 of creating the message. Act 410 includes creating the message, the message including an identifier representing the receiving computer system, message content, and a message router list, the message router list including the one or more preferred routers. For example, the user at the sending computer system 200 can generate a message 201 that includes an indication of an ultimate destination 207, 210, a list of preferred routers 210, and content 212 to be sent.

The method of FIG. 4 also comprises an act 420 of referencing the cached router list. Act 420 includes referencing a cached router list stored at the sending computer system. For example, sending computer system 200 can include a cache of one or more routers that are defined by a network administrator, or are compiled through a series of successful sends and receives, etc. The referencing can be performed, for example, by a comparison module 215 at the sending computer system 200. Following act 420, the method comprises act 430 of modifying the message router list.

Act 430 includes modifying the message router list based on router data contained within the cached router list, wherein a router from the cached router list is added to the message router list or a router is a deleted from the message router list. For example, the comparison module 215 at the sending computer system 200 can rely on routing rules (previously described) in the referral cache 217, and/or in content logic 220 to change the routing list 210 in the original message 201. Accordingly, the comparison module can modify, for example, routing list 210 to be 211, by adding or deleting a router from the routing list if appropriate.

Finally, the method of FIG. 4 comprises an act 440 of sending the message 440. Act 440 includes sending the message to a first router included in the modified router list. Accordingly, after the client has created the message 201, and the sending computer system 200 has reviewed the router list 210 and modified the router list if appropriate, the sending computer system 200 can then relay the message to the “top-most” router on the modified router list 211. As illustrated in FIG. 2, the modified router list 211 identifies “A” as the next most router, and so the sending computer system 200 relays message 202 to “Router A” 230 before the message 202 reaches the receiving computer system 260 identified by “Ultimate ID” 265.

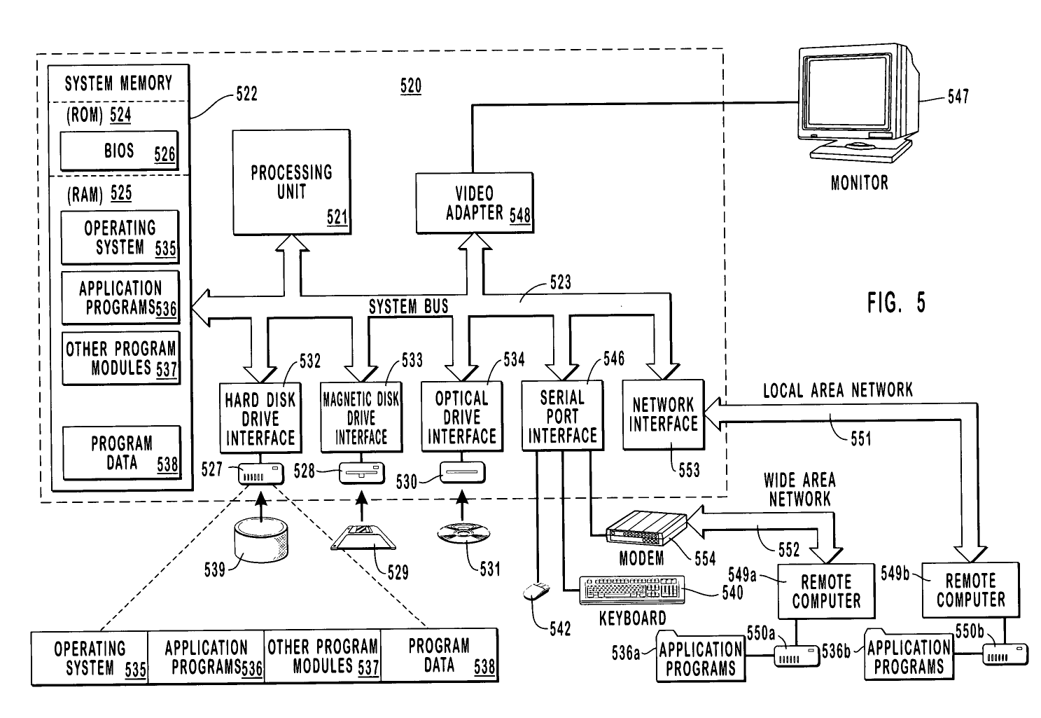

FIG. 5 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where local and remote processing devices perform tasks and are linked (either by hardwired links, wireless links, or by a combination of hardwired or wireless links) through a communications network. In a distributed computing environment, program modules may be located in both local and remote memory storage devices.

With reference to FIG. 5, an exemplary system for implementing the invention includes a general-purpose computing device in the form of a conventional computer 520, including a processing unit 521, a system memory 522, and a system bus 523 that couples various system components including the system memory 522 to the processing unit 521. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help transfer information between elements within the computer 520, such as during start-up, may be stored in ROM 524.

The computer 520 may also include a magnetic hard disk drive 527 for reading from and writing to a magnetic hard disk 539, a magnetic disc drive 528 for reading from or writing to a removable magnetic disk 529, and an optical disc drive 530 for reading from or writing to removable optical disc 531 such as a CD ROM or other optical media. The magnetic hard disk drive 527, magnetic disk drive 528, and optical disc drive 530 are connected to the system bus 523 by a hard disk drive interface 532, a magnetic disk drive-interface 533, and an optical drive interface 534, respectively. The drives and their associated computer-readable media provide nonvolatile storage of computer-executable instructions, data structures, program modules and other data for the computer 520. Although the exemplary environment described herein employs a magnetic hard disk 539, a removable magnetic disk 529 and a removable optical disc 531, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 539, magnetic disk 529, optical disc 531, ROM 524 or RAM 525, including an operating system 535, one or more application programs 536, other program modules 537, and program data 538. A user may enter commands and information into the computer 520 through keyboard 540, pointing device 542, or other input devices (not shown), such as a microphone, joy stick, game pad, satellite dish, scanner, or the like. These and other input devices are often connected to the processing unit 521 through a serial port interface 546 coupled to system bus 523. Alternatively, the input devices may be connected by other interfaces, such as a parallel port, a game port or a universal serial bus (USB). A monitor 547 or another display device is also connected to system bus 523 via an interface, such as video adapter 548. In addition to the monitor, personal computers typically include other peripheral output devices (not shown), such as speakers and printers.

The computer 520 may operate in a networked environment using logical connections to one or more remote computers, such as remote computers 549a and 549b. Remote computers 549a and 549b may each be another personal computer, a server, a router, a network PC, a peer device or other common network node, and typically include many or all of the elements described above relative to the computer 520, although only memory storage devices 550a and 550b and their associated application programs 536a and 536b have been illustrated in FIG. 5. The logical connections depicted in FIG. 5 include a local area network (LAN) 551 and a wide area network (WAN) 552 that are presented here by way of example and not limitation. Such networking environments are commonplace in office-wide or enterprise-wide computer networks, intranets and the Internet.

When used in a LAN networking environment, the computer 520 is connected to the local network 551 through a network interface or adapter 553. When used in a WAN networking environment, the computer 520 may include a modem 554, a wireless link, or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing communications over wide area network 552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In a router, a method of routing a message from a sending computer system to a receiving computer system such that a routing path for the message can be changed before the message reaches the receiving computer system, comprising the following:
an act of receiving a message that originated at the sending computer system and that is to be delivered to the receiving computer system, the message having at least a router list that identifies one or more routers, an ultimate destination identifier, and message content;
an act of accessing routing rules that specify how the message should be routed to the receiving computer system;
an act of comparing at least a portion of the message to the routing rules to determine whether the router list should be reconfigured, wherein the router adds or deletes one or more routers in the router list as appropriate; and
an act of sending the message to a next router in the router list, wherein the next router identifies that it is an appropriate recipient for the message.

2. The method as recited in claim 1, wherein the act of receiving a message that originated at the sending computer system and that is to be delivered to the receiving computer system comprises an act of receiving a SOAP message.

3. The method as recited in claim 1, wherein the routing rules are present in one or more of the router, the next router, the sending computer system, and the message.

4. The method as recited in claim 1, further comprising identifying from a local file at the next router whether the router list should be reconfigured, wherein the next router adds or deletes one or more routers in the router list as appropriate.

5. The method as recited in claim 2, wherein the next router identifies that it is an appropriate target of the sent message based on one or more of the next router's position in the router list, and a router designation contained in the message.

6. The method as recited in claim 2, further comprising, an act of detecting that the ultimate destination is an appropriate recipient of the message upon receiving the message at the ultimate destination.

7. The method as recited in claim 6, wherein the act of detecting that the ultimate destination is the correct recipient comprises:
an act of identifying the one or more routers in the router list sequentially beginning with a top most router;
an act of identifying at the router that the router is a top most router in the router list;
an act of removing the top most router in the router list upon sending the message so that a subsequent router becomes the top most router in the router list; and
an act of confirming at the ultimate destination that the ultimate destination is the top most router in the router list.

8. The method as recited in claim 1, further comprising an act of providing a router preference in the router list prior to relaying the message to the router.

9. The method as recited in claim 1, wherein the router is a user-created router, the user-created router determining whether to add or a delete a next router from the router list based on the content in the message.

10. The method as recited in claim 1, further comprising reconfiguring the router list contained within the message prior to the message reaching the ultimate destination, whether the router list is reconfigured based at least in part on one or more of a router identified in the routing list, the geographic origin of the message, and the message content.

11. The method as recited in claim 1, wherein the act of comparing at least a portion of the message to the routing rules to determine whether the router list should be reconfigured comprises an act of comparing the message content to the routing rules.

12. In a router, a method of routing a message from a sending computer system to a receiving computer system such that a routing path for the message can be changed before the message reaches the receiving computer system, comprising the following:
an act of receiving a message that originated at the sending computer system and that is to be delivered to the receiving computer system, the message having at least a router list that identifies one or more routers, an ultimate destination identifier, and message content;
a step for adjusting a routing path for the message based in part on the ultimate destination indicated in the message, the routing list included in the message, and a referral cache; and
an act of sending the message to a next router in the router list, wherein the next router identifies that it is an appropriate recipient for the message.

13. The method as recited in claim 12, wherein the step for adjusting a routing path for the message comprises:
a corresponding act of accessing routing rules that specify how the message should be routed to the receiving computer system; and
a corresponding act of comparing at least a portion of the message to the routing rules to determine whether the router list should be reconfigured, wherein the router adds or deletes one or more routers in the router list as appropriate.

14. In a sending computer system, a method of routing a message to a receiving computer system such that a routing path for the message can be changed before the message reaches the receiving computer system, comprising the following:
an act of identifying the receiving computer system, and one or more preferred routers by which the message is intended to be relayed to the receiving computer system;
an act of creating the message, the message including an identifier representing the receiving computer system, message content, and a message router list, the message router list including the one or more preferred routers;
an act of referencing a cached router list stored at the sending computer system;
an act of modifying the message router list based on router data contained within the cached router list, wherein a router from the cached router list is added to the message router list or a router is a deleted from the message router list; and
an act of sending the message to a first router included in the modified router list.

15. The method as recited in claim 14, wherein the act of modifying the message router list based on router data contained within the cached router list comprises an act of modifying the message router list based on routing rules that indicate one or more preferred routers through which the message should be relayed before reaching the receiving computer.

16. A computer program product for use in a router, the computer program product for implementing a method for routing a message from a sending computer system to a receiving computer system such that a routing path for the message can be changed before the message reaches the receiving computer system, the computer program product comprising one or more computer-readable media having stored thereon computer executable instructions that, when executed by a processor, cause the router to perform the following:
receive a message that originated at the sending computer system and that is to be delivered to the receiving computer system, the message having at least a router list that identifies one or more routers, an ultimate destination identifier, and message content;
access routing rules that specify how the message should be routed to the receiving computer system;
compare at least a portion of the message to the routing rules to determine whether the router list should be reconfigured, wherein the router adds or deletes one or more routers in the router list as appropriate; and
send the message to a next router in the router list, wherein the next router identifies that it is an appropriate recipient for the message.

17. The computer program product as recited in claim 16, wherein the an act of receiving a message that originated at the sending computer system and that is to be delivered to the receiving computer system comprises an act of receiving a SOAP message.

18. The computer program product as recited in claim 16, wherein the routing rules are present in one or more of the router, the next router, the sending computer system, and the message.

19. The computer program product as recited in claim 16, further comprising identifying from a local file at the next router whether the router list should be reconfigured, wherein the next router adds or deletes one or more routers in the router list as appropriate.

20. The computer program product as recited in claim 17, wherein the next router identifies that it is an appropriate target of the sent message based on one or more of the next router's position in the router list, and a router designation contained in the message.

21. The computer program product as recited in claim 17, further comprising, an act of detecting that the ultimate destination is an appropriate recipient of the message upon receiving the message at the ultimate destination.

22. The computer program product as recited in claim 21, wherein the act of detecting that the ultimate destination is the correct recipient comprises:
an act of identifying the one or more routers in the router list sequentially beginning with a top most router;
an act of identifying at the router that the router is a top most router in the router list;
an act of removing the top most router in the router list upon sending the message so that a subsequent router becomes the top most router in the router list; and
an act of confirming at the ultimate destination that the ultimate destination is the top most router in the router list.

23. The computer program product as recited in claim 16, further comprising an act of providing a router preference in the router list prior to relaying the message to the router.

24. The computer program product as recited in claim 16, wherein the router is a user-created router, the user-created router determining whether to add or a delete a next router from the router list based on the content in the message.

25. The computer program product as recited in claim 16, further comprising reconfiguring the router list contained within the message prior to the message reaching the ultimate destination, whether the router list is reconfigured based at least in part on one or more of a router identified in the routing list, the geographic origin of the message, and the message content.

26. The computer program product as recited in claim 16, wherein the act of comparing at least a portion of the message to the routing rules to determine whether the router list should be reconfigured comprises an act of comparing the message content to the routing rules.

27. A computer program product for use in a sending computer system, the computer program product for a method for routing a message from a sending computer system to a receiving computer system such that a routing path for the message can be changed before the message reaches the receiving computer system, the computer program product comprising one or more computer-readable media having stored thereon computer executable instructions that, when executed by a processor, cause the sending computer system to perform the following:
identify the receiving computer system, and one or more preferred routers by which the message is intended to be relayed to the receiving computer system;
create the message, the message including an identifier representing the receiving computer system, message content, and a message router list, the message router list including the one or more preferred routers;
reference a cached router list stored at the sending computer system;
modify the message router list based on router data contained within the cached router list, wherein a router from the cached router list is added to the message router list or a router is a deleted from the message router list; and
send the message to a first router included in the modified router list.
